(19) United States
(12) Patent Application Publication
(10) Pub. No.: US 2024/0083194 A1
(43) Pub. Date: Mar. 14, 2024

(54) Embossing Die for a Punching Tool

(71) Applicant: ERNI International AG, Bruttisellen (CH)

(72) Inventors: Heiko Schütze, Schorndorf (DE); Victor Carucci, Uhingen (DE); Markus Stammler, Goppingen (DE); Alexander Seibold, Sussen (DE)

(73) Assignee: ERNI International AG, Bruttisellen (CH)

(21) Appl. No.: 18/517,096

(22) Filed: Nov. 22, 2023

Related U.S. Application Data
(63) Continuation of application No. PCT/EP2022/063878, filed on May 23, 2022.

(30) Foreign Application Priority Data
May 25, 2021 (DE) 10 2021 113 473.0

(51) Int. Cl. B44B 5/00; B44B 5/02

(52) U.S. Cl. CPC B44B 5/0052; B44B 5/0019; B44B 5/026

(57) ABSTRACT

An embossing die includes a recess into which a component can be introduced for embossing and an embossing bead protruding into the recess and contacting the component. The recess has a side wall that extends at least partially conically or concavely in an embossing direction.

### CROSS-REFERENCE TO RELATED APPLICATIONS

This application is a continuation of PCT International Application No. PCT/EP2022/063878, filed on May 23, 2022, which claims priority under 35 U.S.C. § 119 to German Patent Application No. 102021113473.0, filed on May 25, 2021.

### FIELD OF THE INVENTION

[present invention relates to an embossing die for a punching tool, which is used for punching and embossing blade contact elements. The invention further relates to an embossing processing station for such a punching tool. Finally, the invention relates to a production method for blade contact elements, which uses the present embossing die in the present embossing processing station in a punching tool.

### BACKGROUND

Punching tools are used, for example, to produce a blade contact element from a metal strip using punching stamps. A die is arranged opposite the stamp. During punching, the edges of the stamp and the die move past each other, whereby they separate a component from the metal strip by shearing. During punching, the metal strip is typically first cut by the stamp. When the tension within the metal strip then becomes too great, the remaining part of the metal strip breaks. The component which has been punched out consequently typically has a cutting region on its outer surface, in which the component was cut, and a break region in which the separation took place.

In blade contact elements, the contact is mostly implemented via precisely this outer surface. During the contact, a Hertzian surface pressure and a high surface quality are required, which are not guaranteed in the break region. In conventional production methods for blade contact elements, a contact surface is embossed onto the punched outer surface of the component. A plurality of processing stations are required, which emboss the surface using pushers. In this manner, primarily the stroke rate of the punching tool is reduced.

In FIG. 1, a side view of a component 1 is shown, which has been produced in a conventional manner by a punching tool. The component 1 is a blade contact element and is contacted via its side wall. The component 1 is punched out of a metal strip by a punching stamp, which moves downwards against a die. Due to the punching, a cutting region 11, in which the component 1 is cut, and a break region 12, in which the component 1 is separated from the metal strip by breaking, form on an outer side 10, i.e., the side wall. The base 13 is flat here, but its shape is not crucial to the later contact and can be formed in any way. Such a component 1 fulfils neither the required Hertzian surface pressure nor the required surface quality for secure contact.

There is a need for a method or a device with which the contact surface of the blade contact element can be formed easily and quickly in a punching machine for safe contact.

### SUMMARY

An embossing die includes a recess into which a component can be introduced for embossing and an embossing bead protruding into the recess and contacting the component. The recess has a side wall that extends at least partially conically or concavely in an embossing direction.

### BRIEF DESCRIPTION OF THE DRAWINGS

Exemplary embodiments of the invention are depicted in the drawings and are explained in more detail in the following description.

FIG. 1 shows a side view of a punched component according to the prior art;

FIG. 2 shows a schematic sectional depiction of an embossing processing station having an embossing die according to a first embodiment of the invention before a component is embossed;

FIG. 3 shows a schematic sectional depiction of the embossing processing station having the embossing die according to the first embodiment of the invention while embossing the component;

FIG. 4 shows a section of the component according to FIG. 3 after embossing;

FIG. 5 shows a schematic sectional depiction of an embossing processing station having an embossing die according to a second embodiment of the invention before the component is embossed;

FIG. 6 shows a schematic sectional depiction of the embossing processing station having the embossing die according to the second embodiment of the invention while embossing the component; and

FIG. 7 shows an isometric view of the embossing die according to an embodiment of the invention.

### DETAILED DESCRIPTION OF THE EMBODIMENTS

A punching tool and an embossing die for a punching tool according to an embodiment punches a component that is finally used as a blade contact element, for example from a metal strip, and then embosses the latter to even out the cutting and break region which typically arise during punching on the surface of the component, and to form a contact surface. As blade contact elements are usually inserted for contact, the contact surface can also be described as an insertion surface.

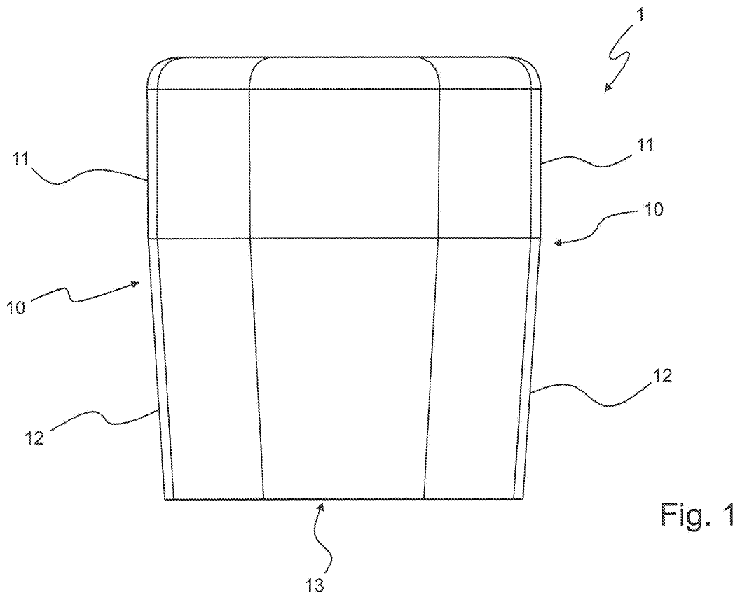

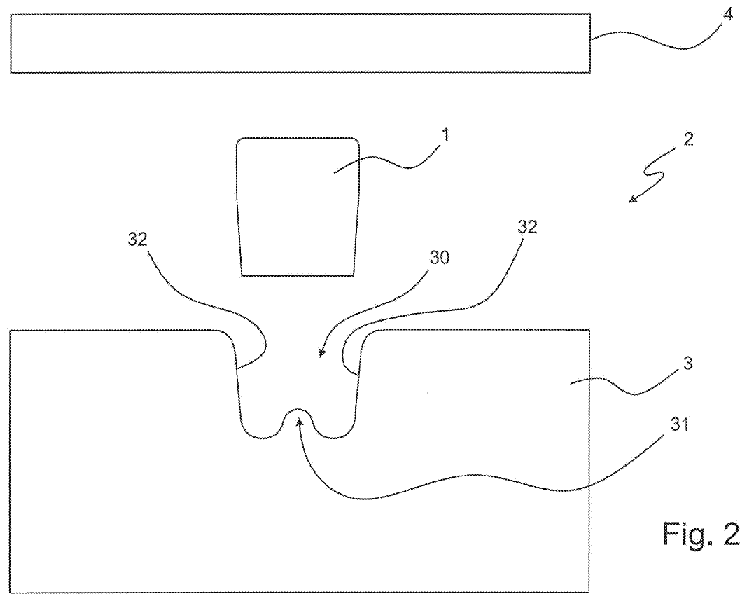

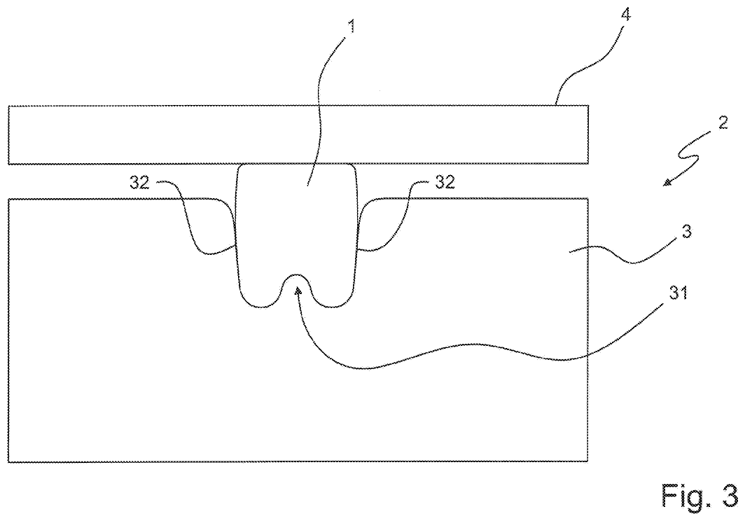

FIGS. 2 and 3 respectively show a section of a first embodiment of an embossing processing station 2 according to the invention for a punching tool, with which the component 1 from FIG. 1 is embossed after punching. The embossing processing station 2 has an embossing die 3 and a holding-down device 4. In the embossing die 3, a recess 30 is formed. According to the invention, the recess 30 has a specific shape, which corresponds to the later shape of the component 1 after embossing and has an embossing bead 31 in the center of its base, which is formed in the shape of a bump and protrudes into the interior of the recess 30.

The recess 30 has at least one side wall 32 in the embossing direction, which runs at least partially conically or concavely. In other words, at least one surface of the embossing die 3, which is located on one of the sides of the recess 30, has an at least partially conical or concave shape. Several side walls 32 of the recess 30, in an embodiment, run conically or concavely. In this first embodiment, the side walls 32 run conically upwards and are curved in a radius that can be predetermined.

FIG. 2 shows the situation before embossing in an open processing situation. In the open processing situation, the holding-down device 4 is arranged in an upper position, removed from the embossing die 3. The component 1 is inserted into the embossing processing station 2 and aligned with the base 13 over the recess 30. For this purpose, the component 1 can be positioned in a known manner in the punching tool via capture pins and be held with spring bases.

In FIG. 3, a closed processing situation when embossing the component 1 is depicted. The holding-down device 4 is driven against the embossing die 3 and presses the component 1 into the recess 30, such that the base 13 of the component 1 comes into contact with the embossing bead 31 and is pressed onto the latter. In an embodiment, the component 1 is aligned with a working stroke of a press of the punching machine in the recess 30 of the embossing die 3. The component 1 is introduced such that the punched surface of the component 1, which typically has the cutting region and the break region, points towards the at least one side wall 32 of the recess 30 which runs conically or concavely. The curved convex contact surface offers a secure connection, as said surface does not have any edges via which the single contact could take place in a non-optimal alignment.

The embossing bead 31 pushes material of the component 1 out of its center to its outer sides 10. The outer sides 10 of the component 1 hit the conical side walls 32 of the recess 30 and are pushed against the latter, such that they are reshaped. In addition, the surface is compressed and smoothed by the pressure, which acts on the outer surface of the component 1 due to the pushing by the embossing bead 31. As a result, a smooth and convex contact surface is easily formed on the punched component by the embossing bead and the at least one side surface which runs at least partially conically or concavely. The component 1 uses as a blade contact element has a convexity and a surface quality which correspond to the requirements.

The holding-down device 4 is not fully driven out of the embossing die 3, but rather is stopped as soon as the outer sides 10 of the component 1 have been sufficiently reshaped. A support for the holding-down device 4 is provided, which pre-determines the height and delimits the holding-down device 4. In this manner, the penetration depth of the embossing bead 31 into the component 15 is also delimited. The height of the support can be re-adjusted via coordination measures, and the embossing on the component 15 can be influenced and adjusted.

In principle, the recess 30 can have any basic shape, in which the finished component 1 should be formed. In an embodiment, the recess 30 has a cross-section which is substantially w-shaped or o-shaped. The w-shaped cross-section thus represents the conical side walls 32, which can also be curved according to the above aspect, and the o-shaped cross-section represents the concave side walls 32 of the recess 30. The embossing bead 31 is formed on the base of the recess 30. The component 1 is introduced from the side opposite the base into the recess 30 and comes into contact with the embossing bead 31 on the base. If the cross-section of the recess 30 is symmetrical, then the embossing bead 31 may be arranged in the center.

According to one aspect, the recess 30 extends through the entire embossing die 3. In an embodiment, the direction in which the recess 30 extends through the entire embossing die 3 is perpendicular to the cross-section specified above and perpendicular to the embossing direction. A long component which has been punched out of a metal strip can thus be embossed throughout.

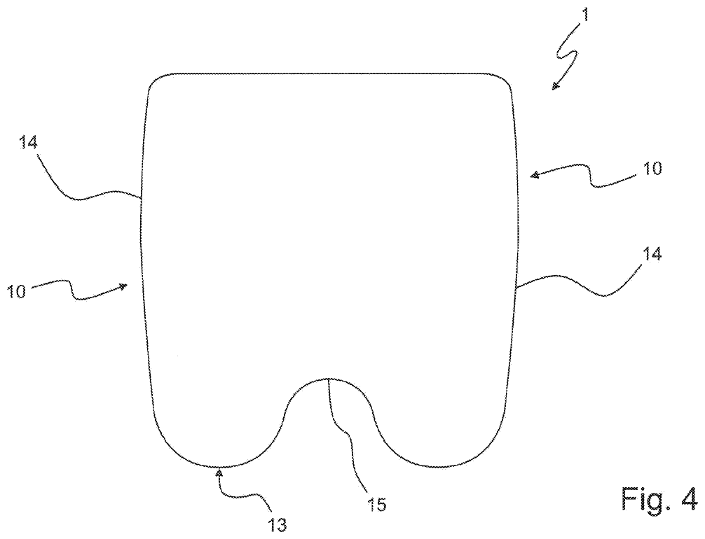

FIG. 4 is a sectional depiction of the component 1 after embossing. The component 1 has been plastically reshaped as depicted during embossing. On the one hand, due to the pressure, which acts on the outer surfaces 10 of the component 1 due to the pushing by the embossing bead 31, the outer sides 10 are re-shaped, such that a convex contact surface 14 forms on the outer sides 10 of the component 1. On the other hand, the outer sides 10 are in particular compressed, and thus smoothed in the break region 12, such that a smooth, convex contact surface 14 forms. The smooth, convex contact surface 14 has a required level of convexity and a high surface quality. An indentation from the embossing bead 31 remains on the base 13 of the component 15.

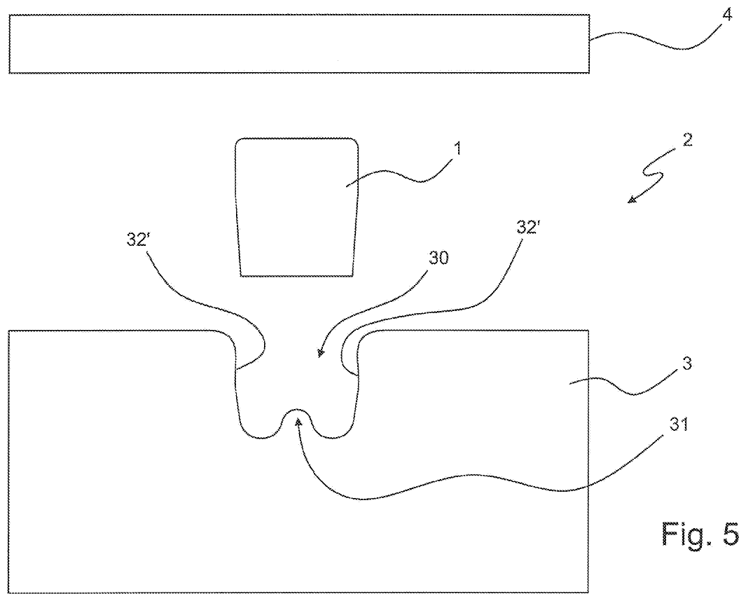

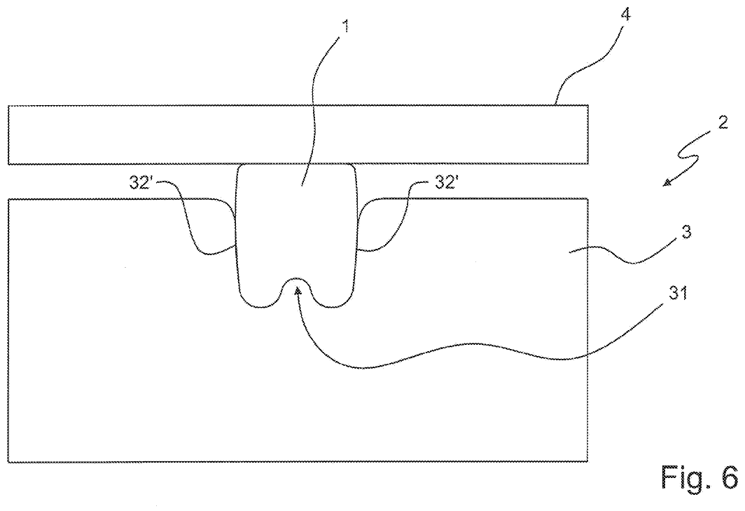

FIGS. 5 and 6 respectively schematically show a section of a second embodiment of the embossing processing station 2 according to the invention for the punching tool, with which the component 1 from FIG. 1 is embossed after punching. The second embodiment differs from the first embodiment only in that the side walls 32′ of the recess 30 are formed concavely. The side walls 32′ are also curved in a radius. In the closed processing situation, the embossing bead 31 pushes the material of the component 1 out of its center towards its outer sides 10. The outer sides 10 of the component 1 hit the concave side walls 32′ of the recess 30 and are pressed against the latter such that they are re-shaped. Purely in principle, if the recess 30 is designed such that it can receive the entire component 1, the holding-down device 4 can be driven completely onto the embossing die 3 in this embodiment.

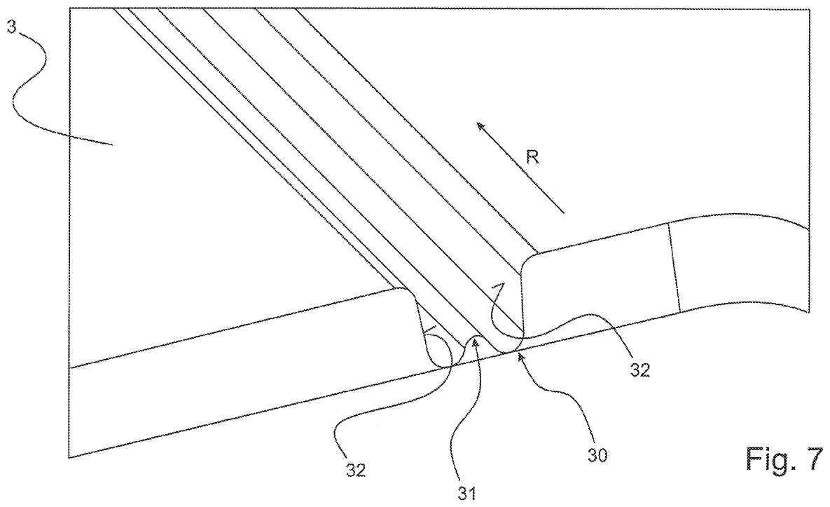

FIG. 7 shows an isometric view of a further embodiment of the embossing die 3 having conical side walls 32. In the following description, however, an embossing die having concave side walls 32′ is used. In a direction R, which lies perpendicular to the embossing direction and to the extension of the embossing die 3 shown in FIGS. 2 and 3, the recess 30 extends, together with the embossing bead 31 and the conical side walls 32, through the entire embossing die 3. A long component 1, which has been punched out of a metal strip, can thus be embossed.

According to a further aspect of the invention, the object is solved by a production method for blade contact elements, in which the following steps are carried out: firstly, in a punching tool, a component 1 which finally serves as a blade contact, is for example punched out of a metal strip. The component 1 is then installed in an embossing processing station 2 according to the invention for the punching tool, as described above, in a recess 30 of an embossing die 3 according to the invention, also as described above. The holding-down device 4 of the embossing processing station is then embossed in the direction of the embossing die 3 and the component 1. The holding-down device 4 pushes the component 1 into the recess 30 of the embossing die 3, such that the component 1 is re-shaped by the embossing bead 31. As explained above, material of the component 1 is pushed from the embossing bead 31 in the direction of the side walls 32 of the recess 30. Due to the conical or concave shape of the at least one side wall 32, the outer surface of the component 1 forms a convex surface on the at least one side wall 32. The surface is additionally compressed and thus smoothed by the pressure, which acts on the outer surface of the component 1 due to the pressing by the embossing bead 31. As a result, a blade contact element is easily and quickly produced with a smooth and convex contact surface.

What is claimed is:

1. An embossing die for a punching tool, comprising:
a recess into which a component can be introduced for embossing, the recess has a side wall that extends at least partially conically or concavely in an embossing direction; and
an embossing bead protruding into the recess and contacting the component.

2. The embossing die of claim 1, wherein the side wall is curved.

3. The embossing die of claim 2, wherein the side wall has a circular shape.

4. The embossing die of claim 1, wherein the recess has a cross-section that is w-shaped or o-shaped.

5. The embossing die of claim 1, wherein the embossing bead is formed on a base of the recess.

6. The embossing die of claim 1, wherein the recess extends through an entirety of the embossing die.

7. An embossing processing station, comprising:
an embossing die including a recess into which a component can be introduced for embossing and an embossing bead protruding into the recess and contacting the component, the recess has a side wall that extends at least partially conically or concavely in an embossing direction; and
a holding-down device pressed onto the embossing die to emboss the component.

8. A method for producing a blade contact element, comprising:
punching a component in a punching tool;
providing an embossing die including a recess and an embossing bead protruding into the recess, the recess has a side wall that extends at least partially conically or concavely in an embossing direction;
inserting the component into the recess of the embossing die; and
embossing the component, the embossing bead re-shapes the component during the embossing.

9. The method of claim 8, wherein the embossing die is a part of an embossing processing station that includes a holding-down device.

10. The method of claim 9, wherein the embossing step including pressing the holding-down device in a direction of the embossing die to press the component into the recess.
